(19) United States
(12) Patent Application Publication
(10) Pub. No.: US 2010/0095509 A1
(43) Pub. Date: Apr. 22, 2010

(54) APPARATUS AND METHOD FOR MANUFACTURING A PENILE CYLINDER HAVING A REINFORCED TIP

(75) Inventor: Randy L. Morningstar, Brooklyn Park, MN (US)

Correspondence Address: COLOPLAST A/S;Attention: Corporate Patents, Holtedam 1, DK-3050 Humlebaek, DK

(73) Assignee: COLOPLAST A/S, Humlebaek (DK)

(21) Appl. No.: 12/580,254

(22) Filed: Oct. 16, 2009

(30) Foreign Application Priority Data
Oct. 16, 2008 (DK) PA 2008 01444

(51) Int. Cl. B23P 11/00

(52) U.S. Cl. 29/428; 29/700

(57) ABSTRACT

An apparatus for manufacturing a penile cylinder having a reinforced tip could include a mandrel having a generally cylindrical body with a proximal end portion and an opposite tip portion. A stud could be secured to the tip portion of the mandrel, and a pre-manufactured tip could be configured to be removably secured to the stud. A method for manufacturing a penile cylinder having a reinforced tip could include steps of: providing an apparatus for manufacturing a penile cylinder having a reinforced tip; removably securing the pre-manufactured tip to the stud; dipping the mandrel, with the pre-manufactured tip, into a semi-liquid material and curing it; and removing the penile cylinder thereby created, with the pre-manufactured tip, from the mandrel.

### FIELD OF THE INVENTION

The present invention relates generally to inflatable penile prostheses. The invention relates specifically to an apparatus and method for manufacturing a penile cylinder having a reinforced tip.

### BACKGROUND OF THE INVENTION

Inflatable penile prostheses (hereinafter, “IPPs”) are known, and have been successfully used in surgically treating male patients suffering from erectile dysfunction. In some so-called three-piece IPPs, an abdominal reservoir is fluidly connected to (i) a pair of inflatable penile cylinders implanted in a patient's penis and (ii) a pump to transfer fluid between the abdominal reservoir and the penile cylinders.

Typically, an apparatus including a mandrel and a dip tank is employed for manufacturing an IPP cylinder. In such a typical apparatus, the mandrel is in a shape of a cylinder to be created with a distal tip portion and a proximal end portion, and the dip tank contains a semi-liquid material such as that utilized in production of BIOFLEX® brand penile prostheses of Coloplast A/S. The mandrel is dipped, tip portion first, downwardly into the material in the dip tank and then removed from the dip tank after being coated in the semi-liquid material. The coated mandrel is then usually rotated approximately 180 degrees so that the tip portion is oriented upwardly, away from the dip tank so that the semi-liquid material disperses evenly along the mandrel during a curing cycle (also hereinafter referred to as “cured” or “curing”). There may be several dipping and curing cycles needed to adequately “build up” a wall thickness in the cylinder being created on the mandrel, and an average time between such cycles may be of a duration to allow the semi-liquid material to at least partially cure so that successive layers of the material deposited on the mandrel has time to stabilize and “out-gas”. Thus, such dip tank operations can be labor-intensive and time-consuming.

As known to those in the art, a penile cylinder provided to a physician typically includes a hole or other aperture through a tip portion of the cylinder, transverse to a major longitudinal axis of the cylinder, so that a suture may be looped therethrough. The suture may thus be used by the physician during implantation surgery to pull the cylinder into the patient's penis. Therefore, as another step in the manufacturing process of the cylinder, the tip portion may be reinforced by further dipping and curing cycles at the tip portion so that there exists sufficient material thickness to accommodate the hole or aperture through which the suture may be looped as aforementioned. As further steps in the manufacturing process, the hole or aperture may then be provided by a subsequent drilling operation, and the cylinder may be finished in a grinding operation to ensure a uniform outside diameter after creation of the hole or aperture.

Accordingly, there may be a need in the art for an apparatus and method for manufacturing a penile cylinder having a reinforced tip of the present invention that might obviate a need for time-consuming and labor-intensive dipping and curing cycles, and finishing processes. Also, there may be a need in the art for an apparatus and method for manufacturing a penile cylinder having a reinforced tip of the present invention that might be relatively simple and economical to manufacture.

### SUMMARY OF THE INVENTION

In accordance with basic aspects of the present invention, an apparatus for manufacturing a penile cylinder having a reinforced tip could include a mandrel having a generally cylindrical body with a proximal end portion and an opposite tip portion. A stud could be secured to the tip portion of the mandrel, and a pre-manufactured tip could be configured to be removably secured to the stud.

Also in accordance with basic aspects of the present invention, a method for manufacturing a penile cylinder having a reinforced tip could include steps of: providing an apparatus for manufacturing a penile cylinder having a reinforced tip; removably securing the pre-manufactured tip to the stud; dipping the mandrel, with the pre-manufactured tip, into a semi-liquid material and curing it; and removing the penile cylinder thereby created, with the pre-manufactured tip, from the mandrel.

### BRIEF DESCRIPTION OF THE DRAWINGS

FIG. 1 is an illustration of an example of an apparatus for manufacturing a penile cylinder having a reinforced tip of the present invention, depicted before use.

FIG. 2 is an illustration of a component of the example of the apparatus shown in FIG. 1.

FIG. 3 is an illustration of the example of the apparatus shown in FIG. 1, depicted in use.

FIG. 4 is an illustration of an example of a penile cylinder created by a method associated with the example of the apparatus for manufacturing a penile cylinder having a reinforced tip shown in FIG. 1.

### DETAILED DESCRIPTION OF THE INVENTION

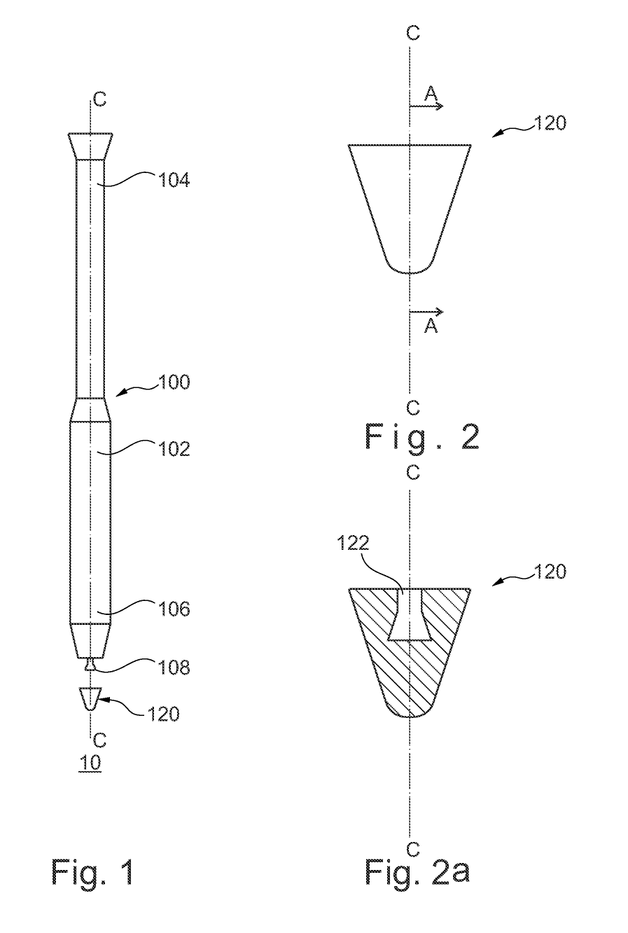

Illustrated in FIGS. 1-2a is an example of an apparatus 10 of the present invention, for manufacturing a penile cylinder having a reinforced tip. As will be further described, FIGS. 1-3 also illustrate an example of a method of the present invention, for manufacturing a penile cylinder having a reinforced tip. Apparatus 10 could include a mandrel 100 that could be defined in part by a generally cylindrical body 102 with a proximal end portion 104 and an opposite tip portion 106. Apparatus 10 could also include a stud 108 that could be secured to tip portion 106 of mandrel 100. Mandrel 100 and stud 108 could share a common central axis C; and thus stud 108 could be concentrically located about axis C. It is to be understood that stud 108 could be integrally formed in and with tip portion 106 of mandrel 100 or alternatively be manufactured as a separate component and then welded or otherwise secured to portion 106 of mandrel 100 as aforementioned. Apparatus 10 could also include a pre-manufactured tip 120, that could be configured to be removably secured to stud 108 of mandrel 100 as will be further described regarding an example of a method of use of apparatus 10. Accordingly, and with reference to FIGS. 2-2a, tip 120 could include a chamber 122 that is located concentrically about central axis C through mandrel 100, stud 108, and tip 120. In particular, stud 108 could removably engage chamber 122 in a push-on or snap-on force-fit or friction-fit arrangement.

Although depicted as generally cylindrical or conical, or a combination of such configurations, it is to be understood that mandrel 100, stud 108, tip 120, and chamber 122 could incorporate any desired geometries to carry out their intended purposes. Mandrel 100 and stud 108 could be manufactured in a process including material selected, separately or together, from a group consisting of steel, aluminum, and plastic. Tip 120 could be manufactured in a process including “Bioflex”-compatible material. The process to manufacture mandrel 100, stud 108, tip 120, and chamber 122 could be selected, separately or together, from a group consisting of casting, machining, milling, and molding. For manufacturing a penile cylinder that has overall dimensions of a typical cylinder, as will be further described, mandrel 100 could have, for example, dimensions of about 10 cm to 30 cm (3.94 inches to 11.81 inches); and stud 108 could have, for example, dimensions of about 0.10 cm to 1.0 cm (0.039 inches to 0.39 inches). Compatibly, tip 120 could have, for example, dimensions of about 0.15 cm to 1.5 cm (0.059 inches to 0.59 inches); and chamber 122 could have, for example, dimensions of about 0.10 cm to 1.0 cm (0.039 inches to 0.39 inches).

It is to be appreciated and understood that a particular embodiment of apparatus 10 could be produced using any suitable materials and fabrication techniques, depending upon particular requirements and configurations of each component of a particular apparatus 10. As such, suitable materials and fabrication techniques could, individually or in combination, employ several different materials (e.g., the aforementioned steel and aluminum, etc.) and several different fabrication steps (e.g., the aforementioned casting, machining, milling, and molding, etc.).

With reference now to FIGS. 1-4, an example of a method for manufacturing a penile cylinder having a reinforced tip of the present invention could include the following steps.

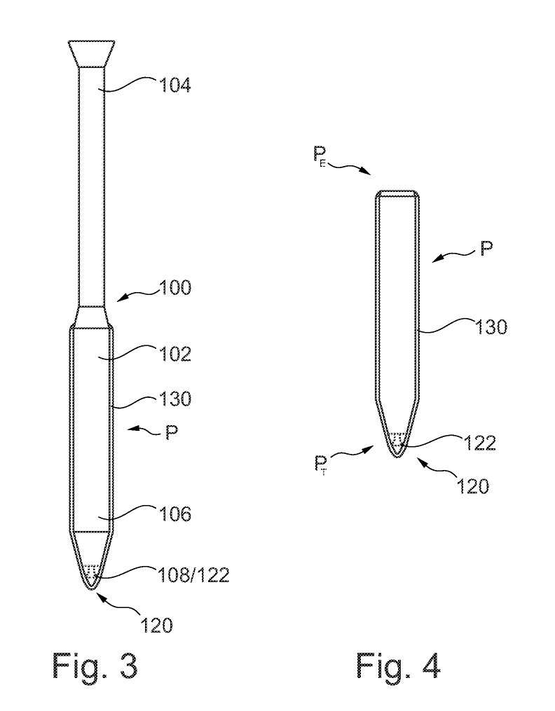

An apparatus 10 could be provided, again including mandrel 100, stud 108, and pre-manufactured tip 120. Tip 120 could be removably secured to mandrel 100 by way of engagement of stud 108 with channel 122, in a force-fit or friction-fit arrangement as aforedescribed. Mandrel 100, with tip 120 thus secured to it, could then be dipped into a dip tank containing a semi-liquid material 130 such as, for example, a “Bioflex” material. Mandrel 100 with tip 120 could be dipped, tip 120 first, downwardly into semi-liquid material 130 in the dip tank and then removed from the dip tank after being coated in material 130 as shown, for example, in FIG. 3. A resulting coated mandrel 100 with tip 120 could then be rotated approximately 180 degrees so that tip 120 is oriented upwardly, away from the dip tank so that semi-liquid material 130 disperses evenly along mandrel 100 (not illustrated). Semi-liquid material 130 could then be cured, thereby creating a substantially hollow and open penile cylinder P as shown, for example, in FIG. 4. As used herein, the terms “substantially hollow and open” could describe a penile cylinder P that (a) has been partially manufactured with (i) a substantially hollow interior or cavity for containing a fluid for expanding the cylinder in use and (ii) an open end portion P_{E} opposite a closed tip portion P_{T}, but that (b) is not yet finished as a complete pressure vessel as known to those of skill in the IPP art. Optionally, additional dipping and curing cycles could be employed to potentially provide greater cylinder wall thickness and out-gassing as aforementioned. It is to be appreciated that semi-liquid material 130 could also be selected from a group consisting of a medical grade thermoplastic material, a medical grade thermoset material, and a medical grade polymer-like material. The semi-liquid material could be further selected from a group consisting of polyurethane and silicone. Finally, cylinder P could be removed from mandrel 100, with stud 108 concurrently disengaging and being removed from chamber 122—thereby leaving tip 120 within cylinder P as desired. Cylinder P, with tip 120, could then be finished for use as an IPP component; and a hole or other suture aperture could be drilled or otherwise made in or through a selected portion of tip 120 so that a suture loop may be provided as aforementioned.

Although not depicted in the drawings, it is to be appreciated and understood that tremendous efficiency could possibly be attained by employing an “assembly line” of several fixtures 100 for, correspondingly, simultaneous creation of holes or apertures in several cylinders P.

It is to be appreciated, from the foregoing disclosure that the present invention night provide heretofore unattainable efficiency in obviating a need for time-consuming and labor-intensive dipping and curing cycles, and finishing processes. Furthermore, it is to be appreciated from the foregoing that the present invention might uniquely and advantageously satisfy a long-felt need for a relatively simple and economical apparatus and method for manufacturing a penile cylinder having a reinforced tip.

It will be appreciated by those in art of IPP manufacturing that novel aspects of the apparatus and method of the present invention could be capable of use in, and beneficial to, virtually any similar manufacturing processes per se—even outside of medical technologies.

While the present invention has been particularly shown and described with reference to the accompanying specification and drawings, it will be understood however that other modifications thereto are of course possible; and all of which are intended to be within the true spirit and scope of the present invention. It should be appreciated that (i) components, dimensions, shapes, and other particulars of example embodiments of the invention aforedescribed may be substituted for others that are suitable for achieving desired results, (ii) various additions or deletions may be made thereto, and (iii) features of the foregoing examples may also be made in combinations thereof. It is also to be understood in general that any suitable alternatives may be employed to provide the apparatus and method for manufacturing a penile cylinder having a reinforced tip of the present invention.

Lastly, of course, the choice of compositions, sizes, and strengths of various aforementioned elements of the present invention are all a matter of design choice depending upon intended uses thereof. Accordingly, these and other various changes or modifications in form and detail of the present invention may also be made therein, again without departing from the true spirit and scope of the invention as defined by the appended claims.

What is claimed is:

1. An apparatus for manufacturing a penile cylinder having a reinforced tip, comprising:
a mandrel, having a generally cylindrical body with a proximal end portion and an opposite tip portion;
a stud, secured to said tip portion of said mandrel; and
a pre-manufactured tip, configured to be removably secured to said stud.

2. The apparatus for manufacturing a penile cylinder having a reinforced tip of claim 1, wherein said mandrel and said stud are manufactured in a process including material selected from a group consisting of steel, aluminum, and plastic.

3. The apparatus for manufacturing a penile cylinder having a reinforced tip of claim 2, wherein said process for manufacturing said mandrel and said stud includes a technique selected from a group consisting of casting, machining, milling, and molding.

4. The apparatus for manufacturing a penile cylinder having a reinforced tip of claim 1, wherein said tip is manufactured in a process including a “Bioflex”-compatible material.

5. The apparatus for manufacturing a penile cylinder having a reinforced tip of claim 4, wherein said process for manufacturing said tip includes a technique selected from a group consisting of casting, machining, milling, and molding.

6. A method for manufacturing a penile cylinder having a reinforced tip, comprising steps of:
providing an apparatus for manufacturing a penile cylinder having a reinforced tip of claim 1;
removably securing said pre-manufactured tip to said stud;
dipping said mandrel with said pre-manufactured tip into a semi-liquid material;
curing said semi-liquid material; and
removing the penile cylinder thereby created, with said pre-manufactured tip, from said mandrel.

7. The method for manufacturing a penile cylinder having a reinforced tip of claim 6, wherein said semi-liquid material is selected from a group consisting of a “Bioflex” material, a medical grade thermoplastic material, a medical grade thermoset material, and a medical grade polymer-like material.

8. The method for manufacturing a penile cylinder having a reinforced tip of claim 6, further comprising a step of providing a suture aperture in a portion of said tip.
